(19) United States
(12) Patent Application Publication
(10) Pub. No.: US 2017/0015024 A1
(43) Pub. Date: Jan. 19, 2017

(54) Molded Product Having Stay Portion and Production Method of Molded Product

(71) Applicant: Teijin Limited, Osaka (JP)

(72) Inventors: Shuhei Suzuki, Osaka-shi (JP); Hodaka Yokomizo, Osaka-shi (JP)

(73) Assignee: Teijin Limited, Osaka (JP)

(21) Appl. No.: 15/210,300

(22) Filed: Jul. 14, 2016

(30) Foreign Application Priority Data
Jul. 15, 2015 (JP) 2015-141207

(51) Int. Cl. B29C 43/02; B29C 43/50; B29C 43/00

(52) U.S. Cl. CPC B29C 43/021; B29C 43/003; B29C 43/50; B29K 2101/12

(57) ABSTRACT

The present invention provides a molded product containing carbon fibers and a thermoplastic resin. The molded product has a stay portion, and the volume V of the stay portion and the thickness t of the molded product satisfy 1<V/t<60 (unit: mm²).

### CROSS-REFERENCE TO RELATED APPLICATIONS

This application claims priority to Japanese Patent Application No. 2015-141207, filed on Jul. 15, 2015, the entire disclosure of which is incorporated herein by reference.

### TECHNICAL FIELD

The present invention relates to a molded product obtained through cold pressing of a molding material and especially relates to the shape of a molded product containing carbon fibers and a thermoplastic resin suitable for the handling of the molded product.

### BACKGROUND ART

Carbon fiber-reinforced composite materials have been widely utilized for structural materials of aircraft, automobiles and the like, general industry or sports use, such as tennis rackets, golf club shafts and fishing rods, and the like, utilizing the high specific strengths and the high specific moduli thereof. The forms of the carbon fibers used for the composite materials are woven fabrics produced using continuous fibers, UD sheets in which the fibers are aligned in one direction, random sheets produced using cut fibers (discontinuous fibers), nonwoven fabrics and the like.

Compression molding for obtaining a molded product of a desired shape by placing a molding material between a bottom mold and a top mold of a compression mold, then closing the molds and compression molding the molding material has been known. When a molding material is compression molded, however, the molded product sometimes stick to the top mold when the mold is opened (releasing) and is not easily removed from the mold, depending on the shape of the molded product, and thus an operator has to remove the molded product from the top mold each time, which causes a problem of decrease in the productivity.

Therefore, for example, Patent Document 1 discloses a compression mold designed to have a stay portion in a desired mold used for molding a molding material containing a thermosetting resin and carbon fibers.

### CITATION LIST

### Patent Documents

Patent Document 1: JP-A-2004-345115

### SUMMARY OF THE INVENTION

### Problems that the Invention is to Solve

In the molding method described in Patent Document 1, however, the fluidity of the resin is extremely high because a thermosetting resin is mainly used. When a molded product is produced using carbon fibers impregnated with a thermosetting resin as in Patent Document 1, the problem of a sink mark does not arise easily, regardless of the shape of the stay portion.

When the method described in Patent Document 1 is used for molding using other plastics such as thermoplastic resins, the appearance of the molded product is poor because the molded surface opposite to the surface with the stay portion has a sink mark.

That is, the present inventors have found that when a molding material containing carbon fibers and a thermoplastic resin is molded by the molding method described in Patent Document 1, a problem arises because the molded surface opposite to the surface with the stay portion has a sink mark.

Therefore, objects of the invention are to provide a molded product which is produced with increased productivity and which has an excellent molded surface even though the molded product contains carbon fibers and a thermoplastic resin and to provide a method for producing the molded product, through intensive investigations of the shape of the stay portion.

### Means for Solving the Problems

In order to solve the above problems, the invention provides the following means.

1. A molded product containing carbon fibers and a thermoplastic resin, having a stay portion,

wherein the volume V of the stay portion and the thickness t of the molded product satisfy 1<V/t<60 (unit: mm²).

2. The molded product according to 1 above, wherein the relation between the depth H of the stay portion and the area S of the opening of the stay portion satisfies 2<S/H<10 (unit: mm).

3. The molded product according to 1 above, wherein the carbon fibers are discontinuous carbon fibers having a weight average fiber length of 1 to 100 mm.

4. The molded product according to 3 above, wherein the discontinuous carbon fibers are dispersed two-dimensionally randomly in an in-plane direction, and the linear expansion coefficient of the molded product in an in-plane direction is 0.1 to 2.5 (×10⁻⁵/° C.).

5. The molded product according to 1 above which is an automotive part.

6. The molded product according to 1 above, wherein the stay portion is for engaging with a mold and holding the molded product in a mold at a desired side.

7. The molded product according to 2 above, wherein the carbon fibers are discontinuous carbon fibers having a weight average fiber length of 1 to 100 mm.

8. The molded product according to 7 above, wherein the discontinuous carbon fibers are dispersed two-dimensionally randomly in an in-plane direction, and the linear expansion coefficient of the molded product in an in-plane direction is 0.1 to 2.5 (×10⁻⁵/° C.).

9. The molded product according to 8 above, wherein the stay portion is for engaging with a mold and holding the molded product in a mold at a desired side.

10. A method for producing a molded product by supplying a molding material containing carbon fibers and a thermoplastic resin between a pair of female and male molds and cold pressing the molding material, wherein the pair of molds has a concavity which engages with the surface of the molded product and holds the molded product in a mold at a desired side, and the volume V of the concavity and the thickness t of the molded product satisfy 1<V/t<60 (unit: mm²).

11. The method for producing a molded product according to 10 above, wherein the relation between the depth H of the concavity and the area S of the opening of the concavity satisfies 2<S/H<10 (unit: mm).

12. The method for producing a molded product according to 10 above, wherein the carbon fibers are discontinuous carbon fibers having a weight average fiber length of 1 to 100 mm.

13. The method for producing a molded product according to 12 above, wherein the discontinuous carbon fibers are dispersed two-dimensionally randomly in an in-plane direction, and the linear expansion coefficient of the molded product in an in-plane direction is 0.1 to 2.5 (×10⁻⁵/° C.).

14. The method for producing a molded product according to 10 above,

wherein an ejector pin is used to remove the molded product from the mold,

the concavity is in an end of the ejector pin,

the Le/De value is one or larger and 50 or smaller, wherein Le (mm) is the length of the ejector pin and De (mm) is the diameter of the minimum circumscribed circle of the cross section of the ejector pin, and

the flexural modulus of the molded product kept in the mold after the cold pressing is 10 GPa or more and 50 GPa or less.

15. The method for producing a molded product according to 10 above, wherein the cold pressing includes at least the following steps A-1) and A-2),

A-1) a step of heating the molding material to a temperature of the melting point of the thermoplastic resin or higher and the decomposition temperature of the thermoplastic resin or lower when the thermoplastic resin is crystalline and to a temperature of the glass transition temperature of the thermoplastic resin or higher and the decomposition temperature of the thermoplastic resin or lower when the thermoplastic resin is amorphous, and

A-2) a step of placing the molding material heated in the step A-1) in the molds adjusted at a temperature lower than the melting point of the thermoplastic resin when the thermoplastic resin is crystalline and at a temperature lower than the glass transition temperature of the thermoplastic resin when the thermoplastic resin is amorphous and applying pressure to the molding material.

16. The method for producing a molded product according to 11 above, wherein the carbon fibers are discontinuous carbon fibers having a weight average fiber length of 1 to 100 mm.

17. The method for producing a molded product according to 16 above, wherein the discontinuous carbon fibers are dispersed two-dimensionally randomly in an in-plane direction, and the linear expansion coefficient of the molded product in an in-plane direction is 0.1 to 2.5 (×10⁻⁵/° C.).

18. The method for producing a molded product according to 17 above,

wherein an ejector pin is used to remove the molded product from the mold,

the concavity is in an end of the ejector pin,

the Le/De value is one or larger and 50 or smaller, wherein Le (mm) is the length of the ejector pin and De (mm) is the diameter of the minimum circumscribed circle of the cross section of the ejector pin, and

the flexural modulus of the molded product kept in the mold after the cold pressing is 10 GPa or more and 50 GPa or less.

19. The method for producing a molded product according to 18 above, wherein the concavity is designed in such a manner that the radius of curvature at the root of the stay portion of the molded product produced becomes more than 0 mm and 5 mm or less.

### Advantageous Effects of the Invention

When the molded product of the invention or the method for producing a molded product of the invention is used, the molded surface opposite to the surface with the stay portion also has an excellent surface appearance.

### BRIEF DESCRIPTION OF THE DRAWINGS

FIGS. 1A and 1B are schematic figures illustrating an example of a molded product of the invention.

FIGS. 2A to 2D are schematic figures illustrating an example of the method for producing a molded product of the invention.

FIGS. 3A to 3C illustrate a conventional method for producing a molded product.

FIGS. 4A to 4C illustrate types of the shape of a stay portion.

FIG. 5 is a schematic figure illustrating the depth of the stay portion.

FIGS. 6A to 6C are schematic figures illustrating a case in which an ejector pin is provided in the bottom mold.

FIGS. 7A and 7B illustrate an example of the shape of the stay portion.

### EMBODIMENTS FOR CARRYING OUT THE INVENTION

The molded product of the invention is a molded product containing carbon fibers and a thermoplastic resin. The molded product has a stay portion, and the volume V of the stay portion and the thickness t of the molded product satisfy 1<V/t<60 (unit: mm²). The stay portion is for engaging with a mold and holding the molded product in a mold at a desired side.

The molded product is obtained by supplying a molding material to a pair of female and male molds.

The “molding material” in the present specification means the material before molding into the molded product and is simply referred to as a “molding material” below.

### [Carbon Fibers]

Generally known carbon fibers are polyacrylonitrile (PAN)-based carbon fibers, petroleum-coal pitch-based carbon fibers, rayon-based carbon fibers, cellulose-based carbon fibers, lignin-based carbon fibers, phenol-based carbon fibers, vapor-grown carbon fibers, and the like. In the invention, carbon fibers of any of these types are suitable for use.

Preferred of these for use in the invention are polyacrylonitrile (PAN)-based carbon fibers, from the standpoint of the excellent tensile strength thereof. In the case of using PAN-based carbon fibers as the carbon fibers, the tensile modulus thereof is preferably in the range of 100 GPa to 600 GPa, more preferably in the range of 200 GPa to 500 GPa, even more preferably in the range of 230 GPa to 450 GPa. The tensile strength thereof is preferably in the range of 2,000 MPa to 10,000 MPa, more preferably in the range of 3,000 MPa to 8,000 MPa.

The carbon fibers to be used in the invention may be ones which have a sizing agent adherent to the surface thereof. In the case of using carbon fibers having a sizing agent adherent thereto, the kind of the sizing agent can be suitably selected in accordance with the kind of the carbon fibers and the kind of the matrix resin, and is not particularly limited.

### [Forms of Carbon Fibers]

### (Fiber Length)

The fiber lengths of the carbon fibers to be used in the invention are not particularly limited, and continuous fibers and discontinuous carbon fibers can be used.

The carbon fibers are preferably discontinuous carbon fibers having a weight average fiber length of 1 to 100 mm. The weight average fiber length of the discontinuous carbon fibers is more preferably 3 to 80 mm, even more preferably 5 to 60 mm. When the weight average fiber length is 100 mm or less, the fluidity of the molding material improves, and a molded product of a desired shape is obtained easily by press molding or the like. On the other hand, when the weight average fiber length is 1 mm or more, the mechanical strength of the molded product improves.

In the invention, carbon fibers which differ in fiber length from one another may be used in combination. In other words, the carbon fibers to be used in the invention may be ones which have a fiber length distribution having a single peak or may be ones which have a fiber length distribution having a plurality of peaks.

The average fiber length of the carbon fibers can be determined for example by measuring the lengths of 100 fibers randomly extracted from the molding material using a vernier caliper or the like to the unit of 1 mm and calculating the average by the expression (e) below. The average fiber length measured here is the weight average fiber length (Lw).

The number average fiber length (Ln) and the weight average fiber length (Lw) are determined by the following expressions (d) and (e), where Li is the length of a carbon fiber and j is the number of the fibers measured.

Ln=ΣLi/j expression (d)

Lw=(ΣLi²)/(ΣLi) expression (e)

In this regard, when the fiber lengths are the same, the number average fiber length and the weight average fiber length are equal. Carbon fibers can be extracted from the molded product (or the molding material) for example by subjecting the molded product (or the molding material) to a heat treatment at 500° C. for about an hour to remove the resin in a furnace.

### (Fiber Diameter)

The average fiber diameter of the carbon fibers to be used in the invention is preferably in the range of 3 to 50 μm in general, more preferably in the range of 4 to 12 μm, even more preferably in the range of 5 to 8 μm.

The average fiber diameter as used herein indicates the diameter of a single fiber of the carbon fiber. Accordingly, when the carbon fiber is in the form of a fiber bundle, the fiber diameter indicates not the diameter of the fiber bundle but the diameter of a carbon fiber (single fiber) constituting the fiber bundle. The average fiber diameter of the carbon fiber can be measured by the method described, for example, in JIS R-7607:2000.

### (Carbon Fiber Bundles)

The form of the carbon fibers to be used in the invention is not particularly limited. The carbon fibers do not have to contain carbon fiber bundles but preferably contain carbon fiber bundles. It is preferable that two or more single fibers are close to each other by a binder, electrostatic force or the like. In this case, the carbon fibers may contain fibers in the form of single fiber, or fibers in the form of fiber bundle may be mixed.

With respect to the carbon fibers in the form of fiber bundle, the numbers of single fibers constituting the respective fiber bundles may be almost the same or different from each other. The number of single fibers constituting a fiber bundle is not particularly limited but is generally in the range of 2 to 100,000.

### (Preferable Carbon Fiber Bundles)

When opened fiber bundles are used, the degree of opening of the opened fiber bundles is not particularly limited. However, it is preferable that the degree of opening of the fiber bundles is controlled and that carbon fiber bundles each containing a specific number of carbon fibers or more and a fewer number of carbon fibers (single fibers) or carbon fiber bundles are contained. In this case, specifically, the carbon fibers preferably contain carbon fiber bundles each composed of single fibers in a critical single fiber number (defined by the expression (b) below) or more (carbon fiber bundles (A)) and other opened carbon fibers (carbon fibers (B)), namely single fibers or fiber bundles each composed of single fibers in a number fewer than the critical single fiber number.

Critical single fiber number=600/D expression (b)

(Here, D is the average fiber diameter (μm) of the carbon fibers.)

In the invention, the proportion of the carbon fiber bundles (A) in the total amount of the carbon fibers in the molded product is preferably 20 to 99 Vol %, more preferably 30 to 95 Vol %, even more preferably 50 Vol % to less than 90 Vol %. When the proportion of the carbon fiber bundles (A) in the total amount of the carbon fibers is 20 Vol % or more, the volume fraction (Vf) of the carbon fibers in the molded product can be increased easily, and as a result, desired mechanical properties are obtained easily. On the other hand, when the proportion of the carbon fiber bundles (A) does not exceed 99 Vol %, the widths of the carbon fiber bundles do not become large, and the aspect ratios to the fiber diameters become small. As a result, desired mechanical properties are obtained easily.

In the invention, the average fiber number (N) of the carbon fiber bundles (A) can be suitably determined within the range not impairing the objects of the invention and is not particularly limited. However, the average fiber number (N) preferably satisfies the following expression (c)

0.6×10⁴/D²<N<6×10⁵/D² expression (c)

(Here, D is the average fiber diameter (μm) of the carbon fibers.)

The average fiber number (N) of the carbon fiber bundles (A) can be adjusted in the above range by adjusting the sizes of the fiber bundles, such as the widths of the fiber bundles and the numbers of the fibers per width, by the preferable production method described below. Specifically, when the average fiber diameter of the carbon fibers in the molded product is 5 to 7 μm, the critical single fiber number is 86 to 120. When the average fiber diameter of the carbon fibers is 5 μm, the average fiber number (N) of the carbon fiber bundles is 240 to 24,000 but is more preferably 300 to 10,000, even more preferably 500 to 5,000. When the average fiber diameter of the carbon fibers is 7 μm, the average fiber number (N) of the carbon fiber bundles is 122 to 12, 200 but is more preferably 200 to 5,000, even more preferably 300 to 3,000. When the average fiber number (N) of the carbon fiber bundles (A) is 0.6×10⁴/D² or more, the volume fraction (Vf) of the carbon fibers in the molded product can be increased easily, and as a result, desired mechanical properties are obtained easily. On the other hand, when the average fiber number (N) of the carbon fiber bundles (A) is 6×10⁵/D² or less, a part which is thicker than the other part is not formed easily, and a void in the molded product is not caused easily.

### (Volume Fraction of Carbon Fibers)

In the invention, the volume fraction of the carbon fibers contained in the molded product defined by the following expression (a) (sometimes simply referred to as “Vf” below) is not particularly limited. However, the volume fraction (Vf) of the carbon fibers in the molded product is preferably 10 to 60 Vol %, more preferably 20 to 50 Vol %, even more preferably 25 to 45 Vol %.

Volume fraction (Vf) of carbon fibers=100×Volume of carbon fibers/(Volume of carbon fibers+Volume of thermoplastic resin) expression (a)

When the volume fraction (Vf) of the carbon fibers in the molded product is 10 Vol % or more, desired mechanical properties are obtained easily. On the other hand, when the volume fraction (Vf) of the carbon fibers in the molded product does not exceed 60 Vol %, the fluidity during press molding or the like is excellent, and a molded product of a desired shape is obtained easily.

### [Thermoplastic Resin]

The thermoplastic resin to be used in the invention is not particularly limited as long as a molded product having desired mechanical properties can be obtained, and the thermoplastic resin can be suitably selected and used in accordance with the use of the molded product to be produced or the like. The thermoplastic resin is not particularly limited, and a thermoplastic resin having a desired softening point or melting point can be suitably selected and used in accordance with the use of the molded product or the like. In general, a thermoplastic resin having a softening point in the range of 180° C. to 350° C. is used, but the thermoplastic resin is not limited to such a thermoplastic resin.

Examples of the thermoplastic resin can include a polyolefin resin, a vinyl resin, a polystyrene resin, a thermoplastic polyamide resin, a polyester resin, a polyacetal resin (a polyoxymethylene resin), a polycarbonate resin, a (meth)acrylate resin, a polyarylate resin, a polyphenylene ether resin, a polyimide resin, a polyethernitrile resin, a phenoxy resin, a polyphenylene sulfide resin, a polysulfone resin, a polyketone resin, a polyether ketone resin, a thermoplastic urethane resin, a fluorocarbon resin and a thermoplastic polybenzimidazole resin.

Examples of the polyolefin resin can include polyethylene resin, polypropylene resin, polybutadiene resin and polymethylpentene resin.

Examples of the vinyl resin can include vinyl chloride resin, vinylidene chloride resin, vinyl acetate resin and polyvinyl alcohol resin.

Examples of the polystyrene resin can include polystyrene resin, acrylonitrile-styrene resin (AS resin) and acrylonitrile-butadiene-styrene resin (ABS resin).

Examples of the polyamide resin can include polyamide 6 resin (nylon 6), polyamide 11 resin (nylon 11), polyamide 12 resin (nylon 12), polyamide 46 resin (nylon 46), polyamide 66 resin (nylon 66) and polyamide 610 resin (nylon 610).

Examples of the polyester resin can include polyethylene terephthalate resin, polyethylene naphthalate resin, polybutylene terephthalate resin, polytrimethylene terephthalate resin and liquid crystal polyester.

An example of the (meth) acrylate resin can be polymethyl methacrylate. Examples of the polyphenylene ether resin can be modified polyphenylene ethers.

Examples of the thermoplastic polyimide resin can include thermoplastic polyimide, polyamide-imide resin and polyetherimide resin.

Examples of the polysulfone resin can include modified polysulfone resins and polyether sulfone resin.

Examples of the polyether ketone resin can include polyether ketone resin, polyether ether ketone resin and polyether ketone ketone resin. An example of the fluorocarbon resin can be polytetrafluoroethylne.

One thermoplastic resin may be used as the only thermoplastic resin in the invention, or two or more thermoplastic resins may be used in the invention. Examples of the embodiment in which two or more thermoplastic resins are used in combination include an embodiment in which thermoplastic resins differing in softening point or melting point are used in combination and an embodiment in which thermoplastic resins differing in average molecular weight are used in combination. However, the combined use of thermoplastic resins is not limited to these examples.

### [Other Agents]

Various fibrous or non-fibrous fillers, such as glass fibers and organic fibers, and additives such as a flame retardant, UV stabilizer, pigment, release agent, softener, plasticizer, and surfactant may be contained in the molding material within a range of not impairing the object of the present invention.

### [State of Carbon Fibers]

The molding material of the invention is obtained preferably from a random mat (a precursor of the molding material) obtained by impregnating a carbon fiber mat with a thermoplastic resin under pressure and heating.

The random mat is composed of a carbon fiber mat of discontinuous carbon fibers having a weight average fiber length of 1 to 100 mm and a thermoplastic resin and is a precursor of the molding material. The carbon fibers in the carbon fiber mat are preferably dispersed two-dimensionally randomly in an in-plane direction.

The state of the carbon fibers is substantially the same after molding, and thus the carbon fibers contained in the molded product, which is obtained by molding the molding material, are also preferably dispersed two-dimensionally randomly in an in-plane direction of the molded product.

Here, that the carbon fibers are dispersed two-dimensionally randomly means that the carbon fibers are oriented disorderly, not in a certain direction, in an in-plane direction of the molding material and are distributed in the plane of the sheet without having specific orientation as a whole. The molding material obtained using the two-dimensionally randomly dispersed discontinuous fibers is a substantially isotropic molding material (or a molded product) without anisotropy in the plane.

In this regard, the degree of two-dimensionally random orientation is evaluated by the ratio of tensile moduli in two orthogonal directions. Specifically, the tensile modulus in a random direction of the molding material (or the molded product) and the tensile modulus in the orthogonal direction are measured, and the larger tensile modulus value is divided by the smaller tensile modulus value to determine the ratio (Eδ). The ratio (Eδ) should be two or smaller, more preferably 1.3 or smaller.

Also, the in-plane direction of the molding material (or the molded product) is an orthogonal direction to the thickness direction of the molding material. While the length direction and the width direction indicate fixed directions, the in-plane direction means an unfixed direction on the same plane (the parallel plane orthogonal to the thickness direction).

### [Production Method of Molded Product]

As the molding method for producing the molded product of the invention, compression molding using cold pressing is used.

### (Cold Pressing Method)

In the cold pressing method, for example, the molding material heated to a first predetermined temperature is introduced to molds set at a second predetermined temperature. Then, pressure is applied to the molding material, and the molding material is cooled.

Specifically, when the thermoplastic resin constituting the molding material is crystalline, the first predetermined temperature is the melting point or higher, and the second set temperature is lower than the melting point. When the thermoplastic resin is amorphous, the first predetermined temperature is the glass transition temperature or higher, and the second set temperature is lower than the glass transition temperature.

That is, the cold pressing method includes at least the following steps A-1) and A-2):

A-1) a step of heating the molding material to a temperature of the melting point of the thermoplastic resin or higher and the decomposition temperature of the thermoplastic resin or lower when the thermoplastic resin is crystalline and to a temperature of the glass transition temperature of the thermoplastic resin or higher and the decomposition temperature of the thermoplastic resin or lower when the thermoplastic resin is amorphous; and

A-2) a step of placing the molding material heated in the step A-1) in molds adjusted at a temperature lower than the melting point of the thermoplastic resin when the thermoplastic resin is crystalline and at a temperature lower than the glass transition temperature of the thermoplastic resin when the thermoplastic resin is amorphous and applying pressure to the molding material.

Through these steps, molding of the molding material can be completed.

In this regard, when the molding material is introduced to the molds, a piece or two or more pieces of the molding material are used in accordance with the thickness of the target molded product. When two or more pieces are used, the pieces may be layered in advance and then heated, or heated molding material pieces may be layered and then introduced to the molds. Also, heated molding material pieces may be layered in the molds one by one. In this regard, the difference in temperature between the molding material at the bottom of the layered pieces and the molding material on top is preferably small, and from this standpoint, the pieces are preferably layered before being introduced to the molds.

The steps should be conducted in the order described above, but another step may be included between the steps. An example of the other step is a shaping step of shaping the molding material in advance into the shape of the mold cavity using a shaping mold which is different from the molds used in the step A-2) before the step A-2).

The step A-2) is a step of applying pressure to the molding material to obtain a molded product of a desired shape. The molding pressure here is not particularly limited but is preferably less than 10 MPa with respect to the projection area of the mold cavity, more preferably 8 MPa or less, even more preferably 5 MPa or less.

Molding pressure of 10 MPa or more is not preferable because a considerable facility investment and an enormous running cost are required especially for molding of a large molded product.

Also, it is of course acceptable to conduct various steps between the above steps during compression molding, and for example, vacuum compression molding in which the molding material is compression molded in a vacuum may also be used.

### [Molded Product]

The molded product of the invention is a molded product containing carbon fibers and a thermoplastic resin. The molded product has a stay portion, and the volume V of the stay portion and the thickness t of the molded product satisfy 1<V/t<60 (unit: mm²). In this regard, the stay portion is for engaging with a mold and holding the molded product in a mold at a desired side.

The molded product is obtained by supplying the molding material to a pair of female and male molds. The molded product is explained below.

### (Stay Portion)

The molded product of the invention has a stay portion capable of engaging with a mold and holding the molded product in a mold at a desired side.

### (Roles of Stay Portion)

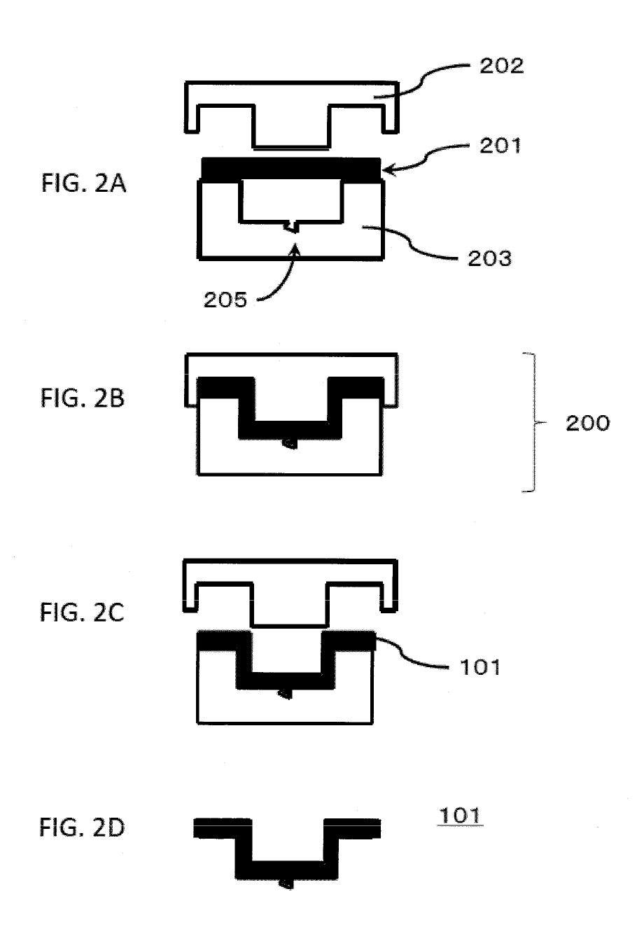

In the method for producing the molded product of the invention, the molding material is supplied between a pair of female and male molds and cold pressed. Here, for example, the pair of female and male molds indicates the bottom mold (203 in FIG. 2A) and the top mold (202 in FIG. 2A) of the mold shown in FIGS. 2A to 2D, and one of the molds is the male mold and the other is the female mold. The mold surface of the bottom mold (for example, 203 in FIG. 2A) or the top mold (for example, 202 in FIG. 2A) has a concavity. The mold surfaces will be described below.

The pair of female and male molds is explained below referring to a bottom mold (for example, 203 in FIG. 2A) and a top mold (for example, 202 in FIG. 2A) as examples.

The mold shown in FIGS. 2A to 2D has a bottom mold (203 in FIG. 2A) and a top mold (202 in FIG. 2A), and the top mold is designed to move upward and downward relative to the bottom mold. The facing surfaces of the bottom mold and the top mold are mold surfaces. That is, the mold surfaces are the surfaces which are touching the molded when molding is completed.

When the molding material (201 in FIG. 2A) shown in FIGS. 2A to 2D is supplied, the top mold moves downward, towards the molding material as shown in FIGS. 2A to 2C to press the molding material while cooling the molding material. The molding material is thus molded into a molded product of a desired shape before the thermoplastic resin is cured. After molding, the top mold moves upward as shown in FIGS. 2C and 2D so that the mold is opened (releasing), and the molded product is removed from the bottom mold.

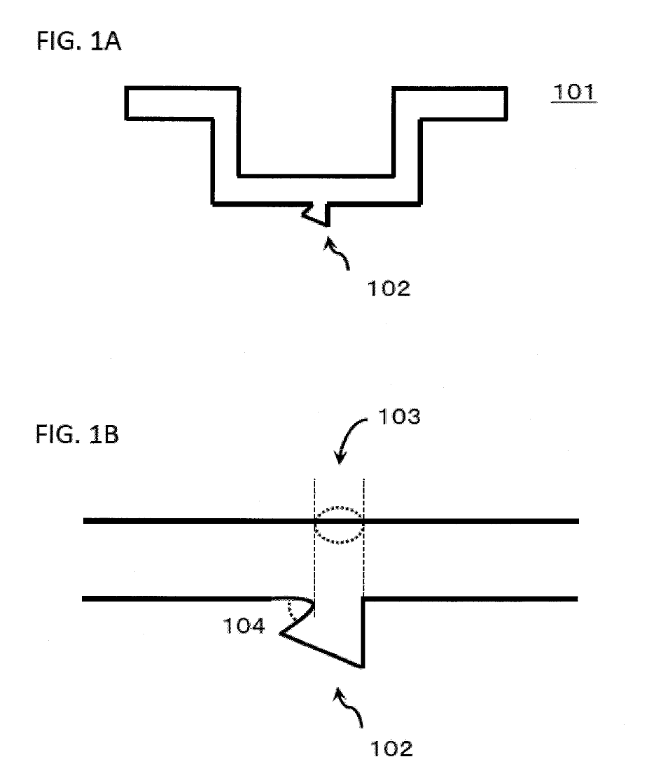

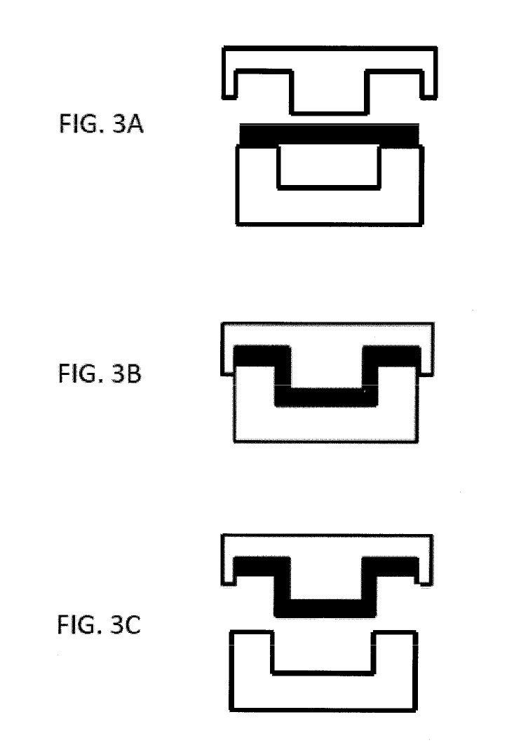

At this point, when the molded product does not have the stay portion (102 in FIGS. 1A and 1B), the compression molded product may strongly stick to the molds when the molded product fits the molds due to the shrinkage by curing during molding and the rigidity of the molded product, and the molded product may be lifted with the top mold (for example FIG. 3C), not being held in the bottom mold, which is desired.

The molded product of the invention is kept in a desired mold because the stay portion can engage with the mold, and the molded product can be prevented from stick to the mold which is not the desired mold when the mold is opened. Accordingly, the molded product can always be kept in the desired mold only, when the mold is opened, and excellent molding can be conducted.

An example of the stay portion is the portion indicated by 102 of the molded product shown in FIGS. 1A and 1B. When the top mold moves upward and the mold is opened after molding, the stay portion 102 can engage with the mold by biting into the mold and can keep the molded product in the bottom mold.

That is, when the mold is opened, the molded product can always be kept in the bottom mold only, and the unstable problem of the biting of the molded product into the top mold can be solved.

### (Shape of Stay Portion)

The stay portion of the invention can engage with a mold because, as shown in FIGS. 1A and 1B, the stay portion has a shape in which the intersection of the molded product and the perpendicular line drawn from at least one point of the stay portion (102 in FIGS. 1A and 1B) to the molded product is outside the opening and thus the molded product cannot be removed in the direction of opening of the mold (undercut).

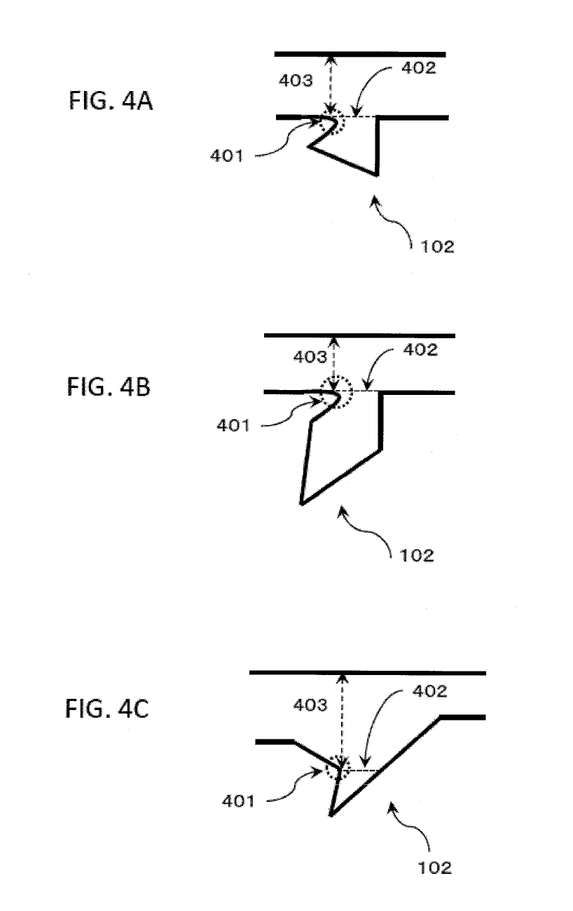

In the invention, the relation between the volume V of the stay portion and the thickness t of the molded product satisfies 1<V/t<60 (unit: mm²). The volume V of the stay portion means the volume of the closed space of the stay portion separated from the rest of the molded product by the plane of the opening of the stay portion. In this regard, the plane of the opening of the stay portion means the plane which starts from the boundary between the portion which can be the undercut and the rest (for example, 401 in FIGS. 4A to 4C) and which is parallel to the molded surface opposite to the surface with the stay portion (for example, the plane 402 in FIGS. 4A to 4C).

Examples of the plane of the opening of the stay portion are indicated by 402 in FIGS. 4A to 4C. The opening is not limited to the example shapes as long as the portion can be the undercut.

Also, t is the thickness of the molded product. When the thickness of the molded product is uneven, the thickness of the molded product around the stay portion can be regarded as t. More strictly, the distance from the portion which can be the undercut to the molded surface opposite to the surface with the stay portion can be regarded as t of the molded product. Examples of the thickness t are indicated by 403 in FIGS. 4A to 4C.

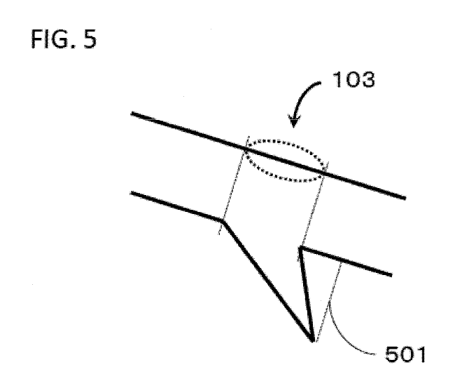

When the V/t value is larger than 60, a sink mark is made in the molded surface opposite to the surface with the stay portion (for example, 103 in FIG. 1B and 103 in FIG. 5), and the appearance of the molded product is impaired markedly.

When the V/t value is smaller than one, it becomes difficult to keep the molded product in the desired mold. The V/t value is preferably in the range of 2<V/t<50, more preferably 2<V/t<40, even more preferably 3<V/t<30. The unit of V/t is [mm²] because V/t may be calculated from the volume V [mm³] and the thickness t [mm].

The V/t [mm²] value indicates the virtual area of the molded product for forming the stay portion, and a sink mark can be prevented when the virtual area is 60 [mm²] or less.

### (Depth H of Stay Portion and Area S of Opening)

In the invention, the relation between the depth H of the stay portion and the area S of the opening is not particularly limited but preferably satisfies 2<S/H<10 (unit: mm).

The depth H of the stay portion in the invention means the length of the perpendicular line drawn from the deepest part of the stay portion to the molded surface and for example means the length indicated by 501 in FIG. 5.

The S/H value is preferably smaller than 10, because a sink mark can be prevented from being made in the molded surface opposite to the surface with the stay portion (for example, 103 in FIG. 1B and 103 in FIG. 5). The S/H value is preferably larger than two, because it becomes easy to form the stay portion and to keep the molded product in the desired mold. The S/H value is more preferably in the range of 3<S/H<9, even more preferably 4<S/H<8.

The unit of S/H is [mm] because S/H may be calculated from the area S of the opening [mm²] and the depth H of the stay portion [mm]. Thus, the lower limit thereof indicates the length which allows the carbon fibers to flow and enter the stay portion. The upper limit thereof indicates the stability of the shape.

### (Radius of Curvature of Stay Portion)

The radius of curvature of the stay portion means the radius of curvature around the portion which can be the undercut and is for example the radius of curvature indicated by 104 in FIG. 1B. The radius of curvature at the root of the stay portion in the invention is not particularly limited but is preferably more than 0 mm and 5 mm or less, more preferably more than 0 mm and 3 mm or less, even more preferably 0.5 mm or more and 3 mm or less. The radius of curvature is preferably more than 0 mm in view of the strength of the stay portion, and the radius of curvature is preferably 5 mm or less because the shape of the molded product is not likely to be affected.

In this regard, the concavity of the mold corresponds to the shape of the stay portion. Thus, the concavity is preferably designed in such a manner that the radius of curvature at the root of the stay portion of the molded product produced becomes within the above range (for example, more than 0 mm and 5 mm or less).

### (Method for Forming Stay Portion and Mold)

The method for forming the stay portion in the invention is not particularly limited, but the following method is used for example.

That is, the method for producing the molded product of the invention is a method for producing the molded product by supplying the molding material containing carbon fibers and a thermoplastic resin between a pair of female and male molds and cold pressing the molding material. The pair of molds has a concavity which engages with the surface of the molded product and holds the molded product in the mold at a desired side, and the volume V of the concavity and the thickness t of the molded product satisfy 1<V/t<60 (unit: mm²).

In this regard, the volume V of the concavity and the volume V of the stay portion are equal. Thus, the preferable range of the V/t value and the reasons for the range are as described above, and the V/t value [mm²] indicates the virtual area of the molded product for filling the concavity with the molding material.

The bottom mold (for example, 203 in FIG. 2A) has the concavity (for example, 205 in FIG. 2A or a concavity formed in the gradient on the mold surface of the bottom mold) so that the stay portion can be formed on the molded product when the molding material (for example, 201 in FIG. 2A) is molded. The concavity in the mold may be formed by any method, and for example, the concavity may be made by scratching the mold surface with a tool such as a chisel or the like.

When the top mold 202 moves upward and the mold is opened after molding, the stay portion (for example, 102 in FIG. 1A) on the surface of the molded product 101 bites into the mold, and thus the molded product can be kept in the bottom mold (for example, 203 in FIGS. 2A to 2C).

### (Depth H of Concavity and Area S of Opening)

In the invention, the relation between the depth H of the concavity and the area S of the opening of the concavity is not particularly limited but preferably satisfies 2<S/H<10 (unit: mm). The depth H of the concavity and the depth H of the stay portion described above are equal. Similarly, the area S of the opening of the concavity and the area S of the opening of the stay portion described above are equal.

Thus, the preferable range of the S/H value and the reasons for the range are as described above. With respect to the relation between the depth H of the concavity and the area S of the opening of the concavity, the lower limit of the S/H value indicates the length which allows the carbon fibers to flow and enter the concavity. The upper limit thereof indicates the stability of the shape.

### (Linear Expansion Coefficient of Molded Product)

In the molded product of the invention, it is preferable that the carbon fibers are discontinuous carbon fibers having a weight average fiber length of 1 to 100 mm, that the discontinuous carbon fibers are dispersed two-dimensionally randomly in an in-plane direction and that the linear expansion coefficient of the molded product in an in-plane direction is 0.1 to 2.5 (×10⁻⁵ μm/° C.). When the linear expansion coefficient is in the range, the depth of a sink mark in the molded surface opposite to the surface with the stay portion can be suitably inhibited.

### [Ejector Pin]

An ejector pin is preferably used to remove the molded product. The ejector pin is explained specifically below. The stay portion is preferably on the ejector pin because the undercut is not broken when the molded product is removed.

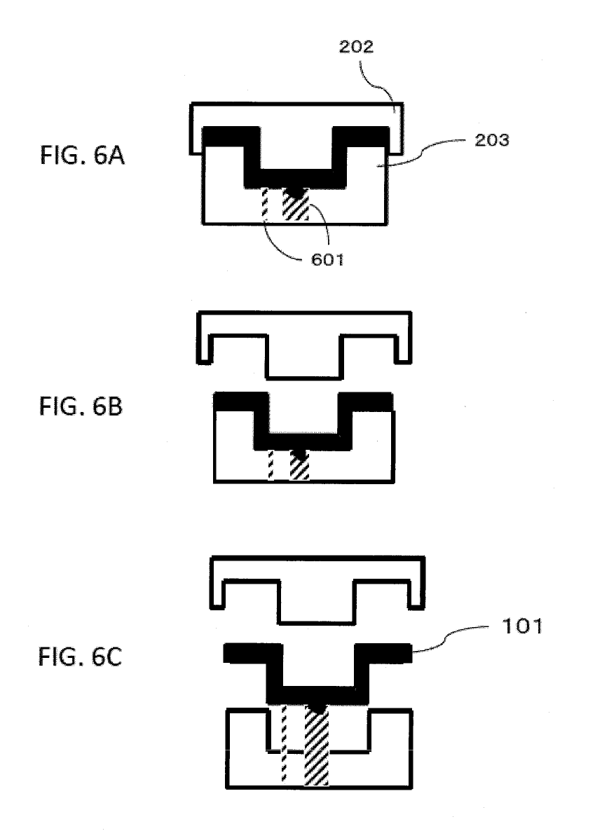

The mold in the invention has an ejector pin 601 provided in the bottom mold 203 as shown in for example FIGS. 6A to 6C. When the top mold 202 moves upward and the mold is opened after compression molding of the molded product 101 between the bottom mold 203 and the top mold 202, the ejector pin 204 moves upward and pushes the molded product 101 kept in the bottom mold 203, and the molded product 101 can be thus removed from the bottom mold 203. Therefore, the ejector pin 601 constitutes a part of the bottom mold 203. The ejector pin 601 moves upward and downward by a driving source which is not shown in the drawings.

### (Shape of Ejector Pin)

The method for producing the molded product of the invention is a method for producing the molded product in which the ejector pin is used to remove the molded product from the mold and in which the concavity is in an end of the ejector pin. The Le/De value is preferably one or larger and 50 or smaller, where Le (mm) is the length of the ejector pin and De (mm) is the diameter of the minimum circumscribed circle of the cross section of the ejector pin, and the flexural modulus of the molded product kept in the mold after cold pressing is preferably 10 GPa or more and 50 GPa or less. In this regard, to determine the flexural modulus of the molded product kept in the mold after cold pressing, the flexural modulus of the molded product removed from the mold can be measured.

An example in which the concavity is in an end of the ejector pin is shown in FIGS. 6A to 6C.

The Le/De value of the ejector pin of one or larger is excellent because the degree of flexibility of the shape of the molded product increases. That is, the molded product can be ejected effectively. The Le/De value is preferably 50 or smaller because the molded product can be ejected from the mold in spite of the rigidity of the molded product produced by cold pressing.

The Le/De value is preferably five or larger and smaller than 45, more preferably 20 or larger and smaller than 40.

### [Applications of Molded Product]

The molded product of the invention is utilized for parts which require strength and rigidity, such as automotive frames, bumper face bar support materials, chassis shells, sheet frames, suspension supports, sunroof frames, bumper beams, frames of two-wheeled vehicles, frames of agricultural equipment, frames of OA devices and machine parts. In particular, the molded product is preferably utilized for automotive parts.

### EXAMPLES

The invention is explained specifically using Examples below, but the invention should not be limited to the Examples. The materials used in the Production Examples and the Examples below are as follows. The decomposition temperatures were measured by thermogravimetric analysis.

PAN-based carbon fibers

Carbon fiber “Tenax” (registered trademark) STS40-24KS manufactured by Toho Tenax Co., Ltd. (average fiber diameter of 7 μm)

Polyamide 6

Abbreviated to PA6 below. A crystalline resin having a melting point of 225° C. and a decomposition temperature (in air) of 300° C.

Polypropylene

Abbreviated to PP below. A crystalline resin having a melting point of 170° C. and a decomposition temperature (in air) of 300° C.

### (1) Analysis of Volume Fraction (Vf) of Carbon Fibers

The thermoplastic resin was removed from a molded product by burning the molded product in a furnace at 500° C. for an hour. The mass of the sample before the treatment and the mass after the treatment were measured, and the mass of the carbon fibers and the mass of the thermoplastic resin were calculated. Next, the volume fractions of the carbon fibers and the thermoplastic resin were calculated using the specific gravities of the components. The volume fraction of the carbon fibers contained in a molding material is also represented by Vf.

Vf=100×Volume of carbon fibers/(Volume of carbon fibers+Volume of thermoplastic resin) Expression (a)

### (2) Analysis of Average Fiber Length of Carbon Fibers Contained in Molded Product

To determine the weight average fiber length of the carbon fibers contained in a molded product, the thermoplastic resin was removed by burning in a furnace at 500° C. for about an hour. Then, the lengths of 100 carbon fibers which were randomly extracted were measured using a vernier caliper and a magnifying glass and recorded in units of 1 mm. The weight average fiber length (Lw) was calculated from the lengths of all the carbon fibers measured (Li, where i is an integer of one to 100) by the following expression.

Lw=(ΣLi²)/(ΣLi) expression (e)

The weight average fiber length of the carbon fibers contained in a molding material can be measured by the same method.

### (3) Evaluation of Sink Mark

Using a laser microscope (VK-X100) manufactured by Keyence Corporation, the cross section of the stay portion of a molded product produced was observed, and the depth of the sink mark in the molded surface opposite to the surface with the stay portion was observed.

Excellent: No sink mark is observed at all.

Good: A sink mark with a depth of less than 30% of the thickness of the molded product is observed, but there are a few cases where the sink mark causes a problem in practical use.

Better: A sink mark with a depth of 30% or more and less than 50% of the thickness of the molded product is observed, but the molded product can be sometimes used practically.

Bad: Because a sink mark with a depth of 50% or more of the thickness of the molded product is observed, the molded product cannot be used.

### (4) Measurement of Linear Expansion Coefficient

Using a tester, type TMA/SS7100 (manufactured by SII), the linear expansion coefficient of a test piece with a shape of 10 mm×5 mm×5 mm (compressed in the direction of the side of 10 mm) was measured at a heating rate of 5° C./min under a compressive load of 49 mN in nitrogen atmosphere from −40 to 200° C.

### (Preparation of Molding Material)

Using carbon fiber “Tenax” (registered trademark) STS40-24KS manufactured by Toho Tenax Co., Ltd. (average fiber diameter of 7 μm) which had been treated with a nylon sizing agent as the carbon fibers and nylon 6 resin A1030 manufactured by Unitika Ltd. as the thermoplastic resin, an isotropic material having a cut length of the carbon fibers of 30 mm, a fiber areal weight of the carbon fibers of 1,800 g/m² and a weight per unit of the nylon resin of 1,500 g/m² was produced by the method described in the Examples of WO2012/105080. The isotropic material was pre-heated at 240° C. for 90 s and then hot pressed at 240° C. for 180 s at a pressure of 2.0 MPa. Next, the material was cooled to 50° C. while applying pressure, and a flat plate of a molding material having a thickness of 2.5 mm and a volume fraction (Vf) of the carbon fibers of 35% was obtained. The molding material (i) obtained was used in the Examples below. The weight average fiber length was 30 mm, and the in-plane isotropy was 1.1.

### Example 1

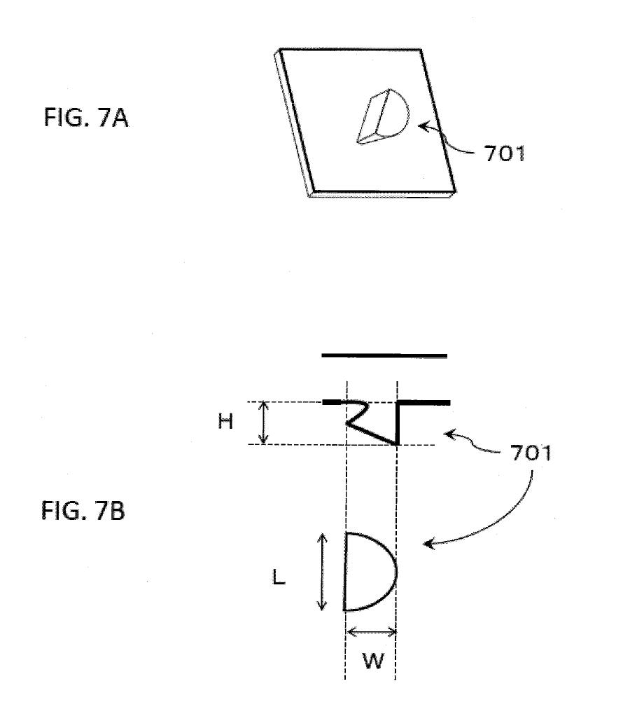

The bottom mold indicated by 203 in FIG. 2A was prepared as a mold for pressing the molding material (i) obtained, and the bottom mold was cut so that the stay portion (701 in FIGS. 7A and 7B) could be formed on the molded product. At this point, the concavity in the bottom mold was designed in such a manner that the length of the stay portion (L in FIG. 7B), the width thereof (W in FIG. 7B), the depth thereof (H in FIG. 7B), the area S of the opening and the volume V of the stay portion became 10 mm, 3 mm, 4 mm, 30 mm² and 60 mm³, respectively. As a matter of course, the depth H of the concavity, the area S of the opening of the concavity and the volume V of the concavity were 4 mm, 30 mm² and 60 mm³, respectively.

In order to adjust the thickness t of the molded product to 10 mm, four pieces of the molding material (i) were layered, cut at a charge ratio of 80% and heated to 255° C. in an infrared heater, and the heated molding material was placed in a mold using the bottom mold adjusted at 130° C. and press molded at a pressure of 10 MPa for 30 seconds. A molded product having a stay portion was thus obtained. Even when the mold was opened and the top mold was lifted after the completion of molding, the molded product remained in the bottom mold.

With respect to the molded product obtained, the stay portion was filled with the material to the tip. The observed depth of the sink mark in the molded surface opposite to the surface with the stay portion was “Excellent”. The results are shown in Table 1.

### Example 2

A molded product was produced in the same manner as in Example 1 except that the molding material (i) was used without layering. Although the thickness t of the molded product reduced, the evaluation was still “Excellent”. The results are shown in Table 1.

### Example 3

A molded product was produced in the same manner as in Example 1 except that the thickness of the molding material was reduced to 2 mm to further reduce the thickness t of the molded product, thereby producing a molding material (ii), and that the molding material (ii) was used without layering. Although the thickness t of the molded product reduced, the evaluation was still “Excellent”. The results are shown in Table 1.

### Example 4

A molded product was produced in the same manner as in Example 3 except that the mold was designed in such a manner that the width of the stay portion (W in FIG. 7B), the depth thereof (H in FIG. 7B), the area S of the opening and the volume V of the stay portion became 4 mm, 5 mm, 40 mm² and 100 mm³, respectively, with respect to the shape of the stay portion. As a matter of course, the depth H of the concavity, the area S of the opening of the concavity and the volume V of the concavity were 5 mm, 40 mm² and 100 mm³, respectively. The results are shown in Table 1. Because the volume of the stay portion was large relative to the thickness of the molded product, the evaluation of the sink mark was “Better”.

### Example 5

A molded product was produced in the same manner as in Example 2 except that the mold was designed in such a manner that the length of the stay portion (L in FIG. 7B), the width thereof (W in FIG. 7B), the depth thereof (H in FIG. 7B), the area S of the opening and the volume V of the stay portion became 9 mm, 4 mm, 7 mm, 36 mm² and 126 mm³, respectively, with respect to the shape of the stay portion (the depth H of the concavity, the area S of the opening and the volume V thereof were the same as those of the stay portion). The results are shown in Table 1. Because the volume of the stay portion was large relative to the thickness of the molded product, the evaluation of the sink mark was “Better”.

### Example 6

The thickness of the molding material was reduced to 1.5 mm to further reduce the thickness of the molded product, and a molding material (iii) was thus prepared. A molded product was produced in the same manner as in Example 2 except that the molding material (iii) was used and that the mold was designed in such a manner that the length of the stay portion (L in FIG. 7B), the width thereof (W in FIG. 7B), the depth thereof (H in FIG. 7B), the area S of the opening and the volume V of the stay portion became 6 mm, 3 mm, 2 mm, 18 mm² and 18 mm³, respectively, with respect to the shape of the stay portion (the depth H of the concavity, the area S of the opening and the volume V thereof were the same as those of the stay portion). The results are shown in Table 1.

### Example 7

A molded product was produced in the same manner as in Example 6 except that 10 pieces of the molding material (iii) were layered (total thickness of 15 mm), that the mold was designed in such a manner that the length of the stay portion (L in FIG. 7B), the depth thereof (H in FIG. 7B), the area S of the opening and the volume V of the stay portion became 8 mm, 4 mm, 24 mm² and 48 mm³, respectively (the depth H of the concavity, the area S of the opening and the volume V thereof were the same as those of the stay portion). The results are shown in Table 1.

### Example 8

A molded product was produced in the same manner as in Example 2 except that the mold was designed in such a manner that the length of the stay portion (L in FIG. 7B), the width thereof (W in FIG. 7B), the depth thereof (H in FIG. 7B), the area S of the opening and the volume V of the stay portion became 5 mm, 2 mm, 4 mm, 10 mm² and 20 mm³, respectively (the depth H of the concavity, the area S of the opening and the volume V thereof were the same as those of the stay portion). The results are shown in Table 1.

### Example 9

A molded product was produced in the same manner as in Example 1 except that the bottom mold having an ejector pin indicated by 203 in FIG. 6A was prepared as the mold for pressing the molding material (i) obtained above and that a concavity was cut in the end of the ejector pin so that the stay portion could be formed on the molded product. The length Le of the ejector pin was 300 mm, and the diameter of the minimum circumscribed circle De was 10 mm (Le/De=30). There was no particular problem with the ejection of the molded product after molding, and the molded product could be ejected successfully.

Also, a test piece having a width of 15 mm and a length of 100 mm was cut out of the molded product obtained above and evaluated by the three-point bending test with a center load in accordance with JIS K 7074. First, the test piece was placed on supporting pins of r=2 mm which were 80 mm apart from each other, and a load was applied to the test piece at the midpoint between the supporting pins with a loading pin of r=5 mm at a testing speed of 5 mm/min. The maximum load and the central deflection were measured, and the flexural modulus was determined. The results are shown in Table 2.

### Example 10

A molded product was produced in the same manner as in Example 9 except that the length Le of the ejector pin was 900 mm and that the diameter of the minimum circumscribed circle De was 90 mm (Le/De=90). The molded product could be produced without problem. However, the ejector pin was bent during the ejection, and the ejector pin could be used only once.

### Comparative Example 1

A molded product was produced in the same manner as in Example 2 except that the mold was designed in such a manner that the length of the stay portion (L in FIG. 7B), the width thereof (W in FIG. 7B), the depth thereof (H in FIG. 7B), the area S of the opening and the volume V of the stay portion became 25 mm, 3 mm, 5 mm, 75 mm² and 187.5 mm³, respectively (the depth H of the concavity, the area S of the opening and the volume V thereof were the same as those of the stay portion).

Because the V/t value was as large as 75, the evaluation of the sink mark was “Bad”. The results are shown in Table 1.

### Comparative Example 2

An attempt was made to produce a molded product in the same manner as in Example 1 except that the mold was designed in such a manner that the length of the stay portion (L in FIG. 7B), the width thereof (W in FIG. 7B), the depth thereof (H in FIG. 7B), the area S of the opening and the volume V of the stay portion became 2 mm, 2 mm, 4 mm, 4 mm² and 8 mm³, respectively. However, the molded product could not be kept in the bottom mold, and thus the investigation was stopped.

### Reference Example 1

A molded product was produced in the same manner as in Comparative Example 1 except that a polypropylene resin (polypropylene, Prime Polypro J108M, manufactured by Prime Polymer Co., Ltd.,) was used as the thermoplastic resin instead of polyamide 6 and glass fibers (glass fiber EX-2500 manufactured by Nippon Electric Glass Co., Ltd. (average fiber diameter of 15 μm and fiber width of 9 mm)) were used instead of the carbon fibers. Because the thermal conductivity of the glass fibers was lower than that of the carbon fibers and the fluidity during molding was higher than in the case of carbon fibers, the evaluation of the sink mark was “Excellent”. The results are shown in Table 1.

TABLE 1

| | Example 1 | Example 2 | Example 3 | Example 4 | Example 5 |
|---|---|---|---|---|---|
| Material | | | | | |
| Fibers | Carbon | Carbon | Carbon | Carbon | Carbon |
| | fibers | fibers | fibers | fibers | fibers |
| Resin | PA6 | PA6 | PA6 | PA6 | PA6 |
| Molded product | | | | | |
| Length L of stay portion mm | 10 | 10 | 10 | 10 | 9 |
| Width W of stay portion mm | 3 | 3 | 3 | 4 | 4 |
| Depth H of stay portion mm | 4 | 4 | 4 | 5 | 7 |
| Area S of opening of stay portion mm² | 30 | 30 | 30 | 40 | 36 |
| Volume V of stay portion mm³ | 60 | 60 | 60 | 100 | 126 |
| Thickness t mm | 10 | 2.5 | 2 | 2 | 2.5 |
| Linear expansion coefficient of molded | 0.5 | 0.5 | 0.5 | 0.5 | 0.5 |
| product (×10⁻⁵/° C.) | | | | | |
| V/t mm² | 6 | 24 | 30 | 50 | 50 |
| S/H mm | 7.5 | 7.5 | 7.5 | 8 | 5 |
| Appearance of molded product | | | | | |
| Sink mark | Excellent | Excellent | Excellent | Better | Better |
| Others | | | | | |

| | | | | Comparative | Comparative | Reference |
|---|---|---|---|---|---|---|
| | Example 6 | Example 7 | Example 8 | Example 1 | Example 2 | Example 1 |
| Material | | | | | | |
| Fibers | Carbon | Carbon | Carbon | Carbon | Carbon | Glass |
| | fibers | fibers | fibers | fibers | fibers | fibers |
| Resin | PA6 | PA6 | PA6 | PA6 | PA6 | PP |
| Molded product | | | | | | |
| Length L of stay portion mm | 6 | 8 | 5 | 25 | 2 | 25 |
| Width W of stay portion mm | 3 | 3 | 2 | 3 | 2 | 3 |
| Depth H of stay portion mm | 2 | 4 | 4 | 5 | 4 | 5 |
| Area S of opening of stay portion mm² | 18 | 24 | 10 | 75 | 4 | 75 |
| Volume V of stay portion mm³ | 18 | 48 | 20 | 187.5 | 8 | 187.5 |
| Thickness t mm | 1.5 | 15 | 2.5 | 2.5 | 10 | 2.5 |
| Linear expansion coefficient of molded | 0.5 | 0.5 | 0.5 | 0.5 | 0.5 | |
| product (×10⁻⁵/° C.) | | | | | | |
| V/t mm² | 12 | 3.2 | 8 | 75 | 0.8 | 75 |
| S/H mm | 9 | 6 | 2.5 | 15 | 1 | 15 |
| Appearance of molded product | | | | | | |
| Sink mark | Good | Excellent | Better | Bad | — | Excellent |
| Others | | | | | Stay | |
| | | | | | portion | |
| | | | | | could not be | |
| | | | | | formed. | |

Note)
PA6: polyamide 6 (nylon 6),
PP: polypropylene

TABLE 2

| | Example 9 | Example 10 |
|---|---|---|
| Molding material | | |
| Fibers | Carbon | Carbon |
| | fibers | fibers |
| Resin | PA6 | PA6 |
| Molded product | | |
| Length L of stay portion mm | 10 | 10 |
| Width W of stay portion mm | 3 | 3 |
| Depth H of stay portion mm | 4 | 4 |
| Area S of opening of stay portion mm² | 30 | 30 |
| Volume V of stay portion mm³ | 60 | 60 |
| Thickness t mm | 10 | 10 |
| Linear expansion coefficient of | 0.5 | 0.5 |
| molded product (×10⁻⁵/° C.) | | |
| V/t mm² | 6 | 6 |
| S/H mm | 7.5 | 7.5 |
| Flexural modulus | 25 | 25 |
| Ejector pin | | |
| Length Le of ejector pin (mm) | 300 | 900 |
| Diameter of minimum circumscribed | 10 | 10 |
| circle De of ejector pin (mm) | | |
| Le/De | 30 | 90 |
| Appearance of molded product | Excellent | Excellent |
| Sink mark | | |

Note)
PA6: polyamide 6 (nylon 6),
PP: polypropylene

### INDUSTRIAL APPLICABILITY

The molded product of the invention and a molded product produced by the production method of the invention can be utilized for structural members such as inner plates, outer plates and structural members of automobiles and frames and housings of electrical appliances and machines and can be preferably utilized as automotive parts.

### DESCRIPTION OF THE REFERENCE NUMERALS AND SIGNS

101: Molded product containing carbon fibers and thermoplastic resin as example of invention
102: Stay portion
103: Molded surface opposite to surface with stay portion
104: Example of measuring point of radius of curvature
201: Molding material containing carbon fibers and thermoplastic resin as example of invention
202: Top mold of mold
203: Bottom mold of mold
205: Concavity in bottom mold designed to form stay portion on molded product
401: Boundary between portion which can be undercut and rest
402: Plane parallel to molded surface opposite to surface with stay portion (plane of opening)
403: Thickness t
501: Length of perpendicular line drawn from deepest part to molded surface (example of depth H of stay portion)
601: Ejector pin
701: Stay portion
L: Length of stay portion
W: Width of stay portion
H: Depth of stay portion

1. A molded product containing carbon fibers and a thermoplastic resin, having a stay portion,
wherein the volume V of the stay portion and the thickness t of the molded product satisfy 1<V/t<60 (unit: mm²).

2. The molded product according to claim 1, wherein the relation between the depth H of the stay portion and the area S of the opening of the stay portion satisfies 2<S/H<10 (unit: mm).

3. The molded product according to claim 1, wherein the carbon fibers are discontinuous carbon fibers having a weight average fiber length of 1 to 100 mm.

4. The molded product according to claim 3, wherein the discontinuous carbon fibers are dispersed two-dimensionally randomly in an in-plane direction, and the linear expansion coefficient of the molded product in an in-plane direction is 0.1 to 2.5 (×10⁻⁵/° C.).

5. The molded product according to claim 1 which is an automotive part.

6. The molded product according to claim 1, wherein the stay portion is for engaging with a mold and holding the molded product in a mold at a desired side.

7. The molded product according to claim 2, wherein the carbon fibers are discontinuous carbon fibers having a weight average fiber length of 1 to 100 mm.

8. The molded product according to claim 7, wherein the discontinuous carbon fibers are dispersed two-dimensionally randomly in an in-plane direction, and the linear expansion coefficient of the molded product in an in-plane direction is 0.1 to 2.5 (×10⁻⁵/° C.).

9. The molded product according to claim 8, wherein the stay portion is for engaging with a mold and holding the molded product in a mold at a desired side.

10. A method for producing a molded product by supplying a molding material containing carbon fibers and a thermoplastic resin between a pair of female and male molds and cold pressing the molding material, wherein the pair of molds has a concavity which engages with the surface of the molded product and holds the molded product in a mold at a desired side, and the volume V of the concavity and the thickness t of the molded product satisfy 1<V/t<60 (unit: mm²).

11. The method for producing a molded product according to claim 10, wherein the relation between the depth H of the concavity and the area S of the opening of the concavity satisfies 2<S/H<10 (unit: mm).

12. The method for producing a molded product according to claim 10, wherein the carbon fibers are discontinuous carbon fibers having a weight average fiber length of 1 to 100 mm.

13. The method for producing a molded product according to claim 12, wherein the discontinuous carbon fibers are dispersed two-dimensionally randomly in an in-plane direction, and the linear expansion coefficient of the molded product in an in-plane direction is 0.1 to 2.5 (×10⁻⁵/° C.).

14. The method for producing a molded product according to claim 10,
wherein an ejector pin is used to remove the molded product from the mold,
the concavity is in an end of the ejector pin,
the Le/De value is one or larger and 50 or smaller, wherein Le (mm) is the length of the ejector pin and De (mm) is the diameter of the minimum circumscribed circle of the cross section of the ejector pin, and
the flexural modulus of the molded product kept in the mold after the cold pressing is 10 GPa or more and 50 GPa or less.

15. The method for producing a molded product according to claim 10, wherein the cold pressing includes at least the following steps A-1) and A-2),
A-1) a step of heating the molding material to a temperature of the melting point of the thermoplastic resin or higher and the decomposition temperature of the thermoplastic resin or lower when the thermoplastic resin is crystalline and to a temperature of the glass transition temperature of the thermoplastic resin or higher and the decomposition temperature of the thermoplastic resin or lower when the thermoplastic resin is amorphous, and
A-2) a step of placing the molding material heated in the step A-1) in the molds adjusted at a temperature lower than the melting point of the thermoplastic resin when the thermoplastic resin is crystalline and at a temperature lower than the glass transition temperature of the thermoplastic resin when the thermoplastic resin is amorphous and applying pressure to the molding material.

16. The method for producing a molded product according to claim 11, wherein the carbon fibers are discontinuous carbon fibers having a weight average fiber length of 1 to 100 mm.

17. The method for producing a molded product according to claim 16, wherein the discontinuous carbon fibers are dispersed two-dimensionally randomly in an in-plane direction, and the linear expansion coefficient of the molded product in an in-plane direction is 0.1 to 2.5 (×10⁻⁵/° C.).

18. The method for producing a molded product according to claim 17,
wherein an ejector pin is used to remove the molded product from the mold,
the concavity is in an end of the ejector pin,
the Le/De value is one or larger and 50 or smaller, wherein Le (mm) is the length of the ejector pin and De (mm) is the diameter of the minimum circumscribed circle of the cross section of the ejector pin, and
the flexural modulus of the molded product kept in the mold after the cold pressing is 10 GPa or more and 50 GPa or less.

19. The method for producing a molded product according to claim 18, wherein the concavity is designed in such a manner that the radius of curvature at the root of the stay portion of the molded product produced becomes more than 0 mm and 5 mm or less.
